(19) United States
(12) Patent Application Publication
(10) Pub. No.: US 2010/0027622 A1
(43) Pub. Date: Feb. 4, 2010

(54) Methods and apparatus for efficient first-pass encoding in a multi-pass encoder

(76) Inventors: Gokce Dane, San Diego, CA (US); Xiaoan Lu, Princeton, NJ (US); Cristina Gomila, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/311,668

(22) PCT Filed: Oct. 22, 2007
(86) PCT No.: PCT/US2007/022422

§ 371 Date: Apr. 8, 2009

(51) Int. Cl. H04N 7/12

(52) U.S. Cl. 375/240.12; 375/E07.001

(57) ABSTRACT

There are provided methods and apparatus for efficient first-pass encoding in a multi-pass encoder. An apparatus includes a multi-pass video encoder for performing a first-pass encoding of input image data for at least one picture by sub-sampling at least a portion of the input image data prior to the first-pass encoding. The sub-sampling is at least one of spatial sub-sampling and temporal sub-sampling.

### CROSS-REFERENCE TO RELATED APPLICATIONS

This application claims the benefit of U.S. Provisional Application Ser. No. 60/862,778, filed Oct. 25, 2006, which is incorporated by reference herein in its entirety.

### TECHNICAL FIELD

The present principles relate generally to video encoding and, more particularly, to methods and apparatus for efficient first-pass encoding in a multi-pass encoder.

### BACKGROUND

The efficiency of a multi-pass video encoding system depends on the accuracy of the information available about the input video. The information about the video can either be available as a meta data or can be collected during a first encoding pass. Utilizing this information, an effective multi-pass algorithm assigns bits to specific segments of the video sequence in a way such that a constant video quality is obtained for all pictures. A more accurate distribution of bits across pictures can be obtained if the information about the video is reliable.

In order to distribute bits across pictures properly, a first-pass is typically used to collect information on the video to be coded. The first-pass can either involve a pre-analysis or a full-encoding. A full-encoding can be done in a simplified manner by encoding pictures only in intra mode. A full-encoding can also be done in a regular manner by encoding pictures in inter and intra modes. A first-pass with a full-encoding collects more reliable information about the video complexity and yields better video quality compared to a pre-analysis. Further, if the first-pass encoder operates with similar configuration settings to the second-pass encoder, the reliability of the data collected from first-pass increases. However this is computationally more complex.

In general, most multi-pass video encoding systems have limitations on the computational complexity of the overall multi-pass encoding system. Therefore, such systems typically cannot afford to have a first-pass encoder that operates under settings very similar to a second-pass encoder. Although this is not a mandatory situation, it is a very typical scenario for most multi-pass encoding systems. Generally, the first-pass encoder should run quickly while providing reliable statistics to the following passes.

The complexity of the first-pass encoding depends on the design of a particular multi-pass encoding system. For instance, in a first prior art multi-pass video encoding system, the first-pass encoding is run at a higher quality level and takes more time. While this level of complexity could be acceptable to some applications, most systems that aim at having a real-time or close to real-time response require a simple yet effective first encoding pass.

As noted above, the first-pass of a multi-pass system can be implemented either as a pre-analysis step/stage (hereinafter “pre-analysis stage”) or as a full-encoding.

Regarding a pre-analysis stage as the first-pass of a multi-pass video encoding system, the pre-analysis stage can perform simple picture differencing or variance calculation to collect video information. The second-pass encoding runs based on the information collected from first-pass. The complexity of the pre-analysis is low (i.e., the run-time for the first-pass is short) when compared to a full-encoding pass. However, the information collected from pre-analysis is not very reliable and this affects the overall performance in terms of video quality. Since high quality is the main requirement of many high definition video applications, advanced methods such as a full-encoding is essential for the first-pass.

Regarding a full-encoding stage as the first-pass of a multi-pass video encoding system, a full-encoding can be performed in various ways.

For example, as one example of a first-pass full-encoding stage, the first-pass full-encoding can be performed using the original input video sequence with intra only encoding. In this case, the bits that are obtained from encoding of intra pictures can be used to guess the bits of intra or inter pictures that will be used in the following passes. However, the guessing of bits of inter pictures from intra pictures is not very reliable since intra and inter pictures are encoded using different respective methods.

As another example of a first-pass full-encoding stage, the first-pass full-encoding can be performed using the original input video sequence with intra and inter encoding by using a fixed encoder configuration setting. This type of encoding can generate more reliable information to guess the bits of pictures in the following passes compared to an intra only encoding method. However the fixed configuration setting that is used in the first-pass encoding may not match the configuration settings of the following passes. Therefore, the accuracy of the bits distribution for the following passes may suffer.

Yet another example of a first-pass full-encoding state, the first-pass full-encoding can also be performed using the original input video sequence with a variety of encoder configuration settings. Changing encoder configuration settings implies that the first-pass encoding is done multiple times for each of these settings. If the setting that gives the best performance in first-pass encoding is applied to the second-pass encoding, better overall video quality can be obtained in this manner.

Thus, although a first-pass with full-encoding improves the video quality, it is inefficient in terms of encoding time.

Turning to FIG. 1, a multi-pass video encoding system is indicated generally by the reference numeral 100.

The multi-pass video encoding system 100 includes a first pass encoder 110 having a first output connected in signal communication with a first input of a second pass encoder 130. A second output of the first pass encoder 110 is connected in signal communication with an input of a complexity analyzer 120. An output of the complexity analyzer 120 is connected in signal communication with a third input of the second pass encoder 130.

A first input of the first pass encoder 110 and a second input of the second pass encoder 130 are available as inputs to the multi-pass video encoding system 100, for receiving a video source signal. A second input of the first pass encoder 110 and a fourth input of the second pass encoder 130 are available as inputs of the multi-pass video encoding system 100, for receiving configuration data. An output of the second pass encoder 130 is available as an output of the multi-pass video encoding system 100, for outputting a bitstream.

Thus, as noted above, the input to the multi-pass video encoding system 100 is the original video source to be encoded and the configuration data which each encoder will use. The configuration data that determines the encoder settings may be different for each pass. The same video source is fed both to first-pass and second-pass encoders as an input in a typical multi-pass encoder. The information obtained from the first-pass encoding performed by the first pass encoder 110 is analyzed by the complexity analyzer 120. The second-pass encoder 130 can take information both from the complexity analyzer 120 and the first-pass encoder 110 directly as inputs in addition to the input video source. The information that is passed to the second-pass encoder 130 by the complexity analyzer 120 can be bits for each picture type. The information that is passed to the second-pass encoder 130 from the first-pass encoder 110 can be motion vectors. The output of the multi-pass video encoding system 100 is the compressed bit-stream that is typically compliant with one of the video compression standards such as, for example, the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), and the ISO/IEC MPEG-2 standard.

Turning to FIG. 2, a method for performing a multi-pass video encoding is indicated generally by the reference numeral 200.

The method 200 includes a start block 201 that passes control to a function block 209 (e.g., a manual operation function block). The function block 209 involves performing an encoder setup, and passes control to a function block 210. The function block 210 performs a first encoding pass, and passes control to a function block 220. The function block 220 performs a complexity analysis, and passes control to a function block 230. The function block 230 performs a second encoding pass, and passes control to an end block 240.

### SUMMARY

These and other drawbacks and disadvantages of the prior art are addressed by the present principles, which are directed to methods and apparatus for efficient first-pass encoding in a multi-pass encoder.

According to an aspect of the present principles, there is provided an apparatus. The apparatus includes a multi-pass video encoder for performing a first-pass encoding of input image data for at least one picture by sub-sampling at least a portion of the input image data prior to the first-pass encoding. The sub-sampling is at least one of spatial sub-sampling and temporal sub-sampling.

According to another aspect of the present principles, there is provided a method. The method includes performing a first-pass encoding of input image data for at least one picture by sub-sampling at least a portion of the input image data prior to the first-pass encoding. The sub-sampling is at least one of spatial sub-sampling and temporal sub-sampling.

According to yet another aspect of the present principles, there is provided an apparatus. The apparatus includes a multi-pass video encoder for performing a first-pass encoding of input image data for at least one picture, and performing an analysis of information from the first-pass encoding to enhance a reliability of the information for use in a subsequent complexity analysis occurring before a subsequent-pass encoding.

According to still another aspect of the present principles, there is provided a method. The method includes performing a first-pass encoding of input image data for at least one picture, and performing an analysis of information from the first-pass encoding to enhance a reliability of the information for use in a subsequent complexity analysis occurring before a subsequent-pass encoding.

According to a further aspect of the present principles, there is provided an apparatus for use in a multi-pass video encoder. The encoder is for at least performing a first-pass encoding of input image data for at least one picture. The apparatus includes a sub-sampler for sub-sampling at least a portion of the input image data prior to the first-pass encoding. The sub-sampling is at least one of spatial sub-sampling and temporal sub-sampling.

According to a still further aspect of the present principles, there is provided a method for use in a multi-pass video encoder. The encoder is for at least performing a first-pass encoding of input image data for at least one picture. The method includes sub-sampling at least a portion of the input image data prior to the first-pass encoding. The sub-sampling is at least one of spatial sub-sampling and temporal sub-sampling.

According to a yet further aspect of the present principles, there is provided an apparatus for use in a multi-pass video encoder. The encoder is for at least performing a first-pass encoding of input image data for at least one picture. The apparatus includes a sub-sampling analyzer for performing an analysis of information from the first-pass encoding to enhance a reliability of the information for use in a subsequent complexity analysis occurring before a subsequent-pass encoding.

According to an additional aspect of the present principles, there is provided a method for use in a multi-pass video encoder. The encoder is for at least performing a first-pass encoding of input image data for at least one picture. The method includes performing an analysis of information from the first-pass encoding to enhance a reliability of the information for use in a subsequent complexity analysis occurring before a subsequent-pass encoding.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for a multi-pass video encoding system, according to the prior art;

FIG. 2 is a block diagram for a method for performing a multi-pass video encoding, according to the prior art;

FIG. 3 is a block diagram for an exemplary multi-pass video encoding system with sub-sampling to which the present principles may be applied, in accordance with an embodiment of the present principles;

FIG. 4 is a block diagram for an exemplary multi-pass video encoding system with sub-sampling and information analysis to which the present principles may be applied, in accordance with an embodiment of the present principles;

FIG. 5 is a block diagram for an exemplary video encoder for use in a multi-pass video encoding system to which the present principles may be applied, in accordance with an embodiment of the present principles;

FIG. 6 is a flow diagram for an exemplary method for multi-pass video encoding with sub-sampling, in accordance with an embodiment of the present principles; and

FIG. 7 is a flow diagram for an exemplary method for multi-pass video encoding with sub-sampling and information analysis, in accordance with an embodiment of the present principles.

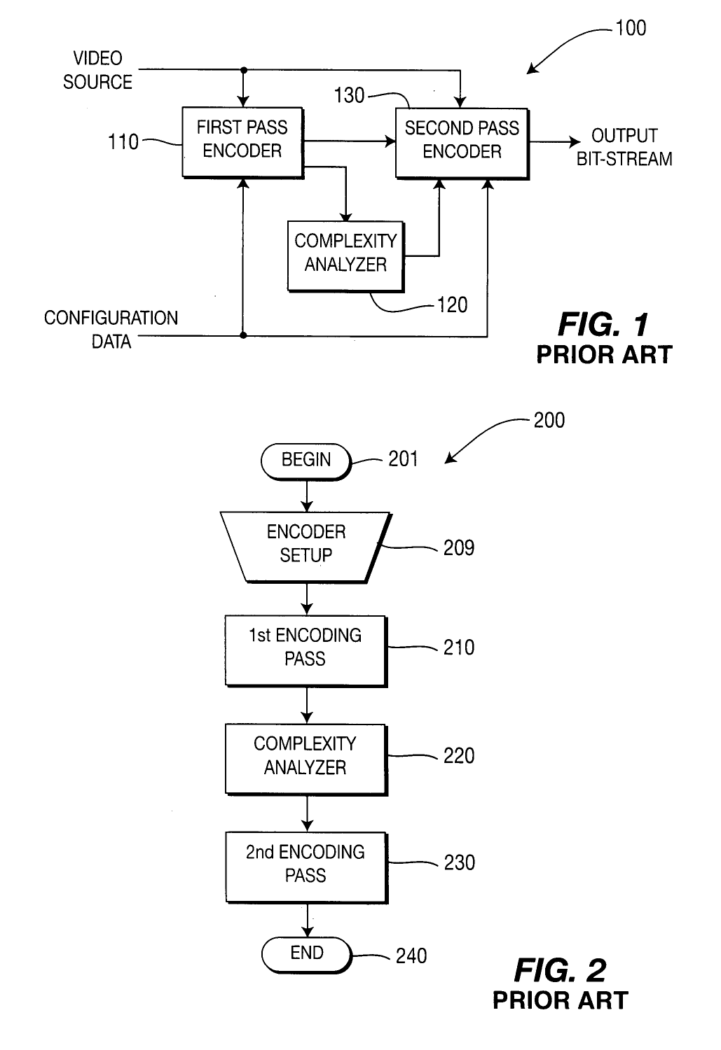

### DETAILED DESCRIPTION

The present principles are directed to methods and apparatus for efficient first-pass encoding in a multi-pass encoder.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

Also, it is to be appreciated that the phrase “image data” is intended to refer to data corresponding to any of still images and moving images (i.e., a sequence of images including motion).

It is to be appreciated that the use of the term “and/or”, for example, in the case of “A and/or B”, is intended to encompass the selection of the first listed option (A), the selection of the second listed option (B), or the selection of both options (A and B). As a further example, in the case of “A, B, and/or C”, such phrasing is intended to encompass the selection of the first listed option (A), the selection of the second listed option (B), the selection of the third listed option (C), the selection of the first and the second listed options (A and B), the selection of the first and third listed options (A and C), the selection of the second and third listed options (B and C), or the selection of all three options (A and B and C). This may be extended, as readily apparent by one of ordinary skill in this and related arts, for as many items listed.

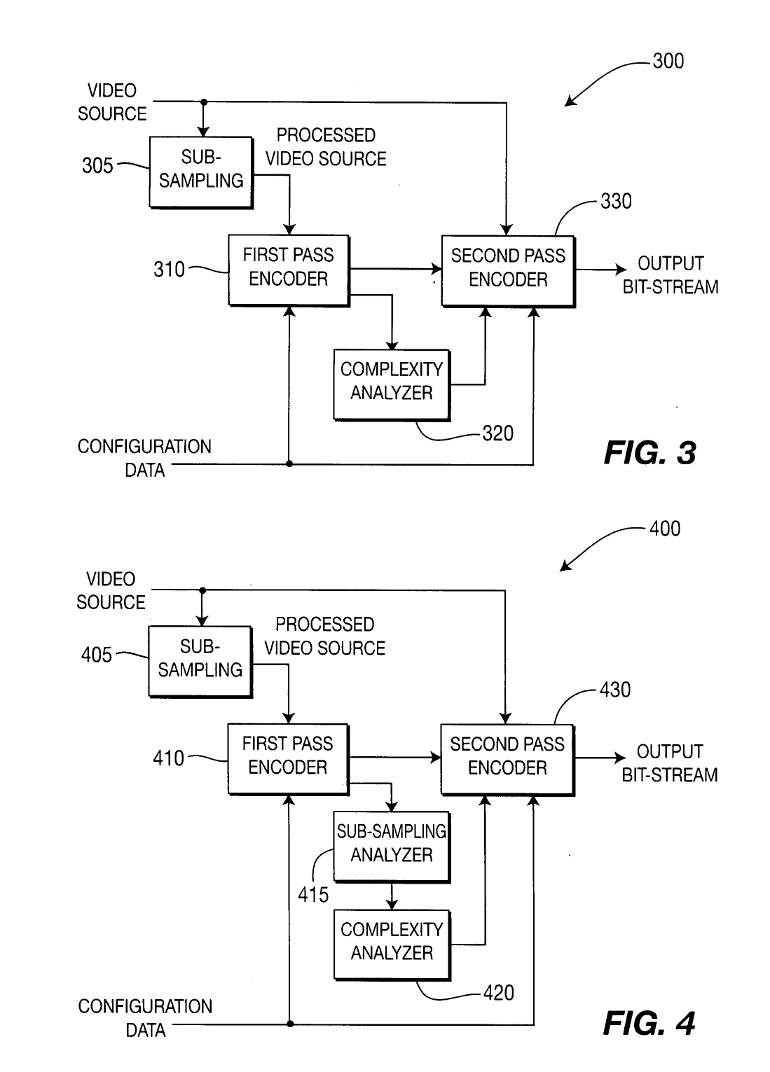

Turning to FIG. 3, an exemplary multi-pass video encoding system with sub-sampling is indicated generally by the reference numeral 300.

The multi-pass video encoding system 300 includes a sub-sampler 305 having an output connected in signal communication with a first input of a first pass encoder 310. The first pass encoder 310 has a first output connected in signal communication with an input of a complexity analyzer 320. An output of the complexity analyzer 320 is connected in signal communication with a first input of a second pass encoder 330. A second output of the first pass encoder 310 is connected in signal communication with a second input of the second pass encoder 330.

An input of the sub-sampler 305 and a fourth input of the second pass encoder are available as inputs of the multi-pass video encoding system 300, for receiving a video source signal. A second input of the first pass encoder 310 and a third input of the second pass encoder 330 are available as inputs of the multi-pass video encoding system 300, for receiving configuration data. An output of the second pass encoder 330 is available as an output of the multi-pass video encoding system 300, for outputting a bitstream.

Turning to FIG. 4, an exemplary multi-pass video encoding system with sub-sampling and information analysis is indicated generally by the reference numeral 400.

The multi-pass video encoding system 400 includes a sub-sampler 405 having an output connected in signal communication with a first input of a first pass encoder 410. The first pass encoder 410 has a first output connected in signal communication with an input of a sub-sampling analyzer 415. An output of the sub-sampling analyzer 415 is connected in signal communication with an input of a complexity analyzer 420. An output of the complexity analyzer 420 is connected in signal communication with a first input of a second pass encoder 430. A second output of the first pass encoder 410 is connected in signal communication with a second input of the second pass encoder 430.

An input of the sub-sampler 405 and a fourth input of the second pass encoder are available as inputs of the multi-pass video encoding system 400, for receiving a video source signal. A second input of the first pass encoder 410 and a third input of the second pass encoder 430 are available as inputs of the multi-pass video encoding system 400, for receiving configuration data. An output of the second pass encoder 430 is available as an output of the multi-pass video encoding system 400, for outputting a bitstream.

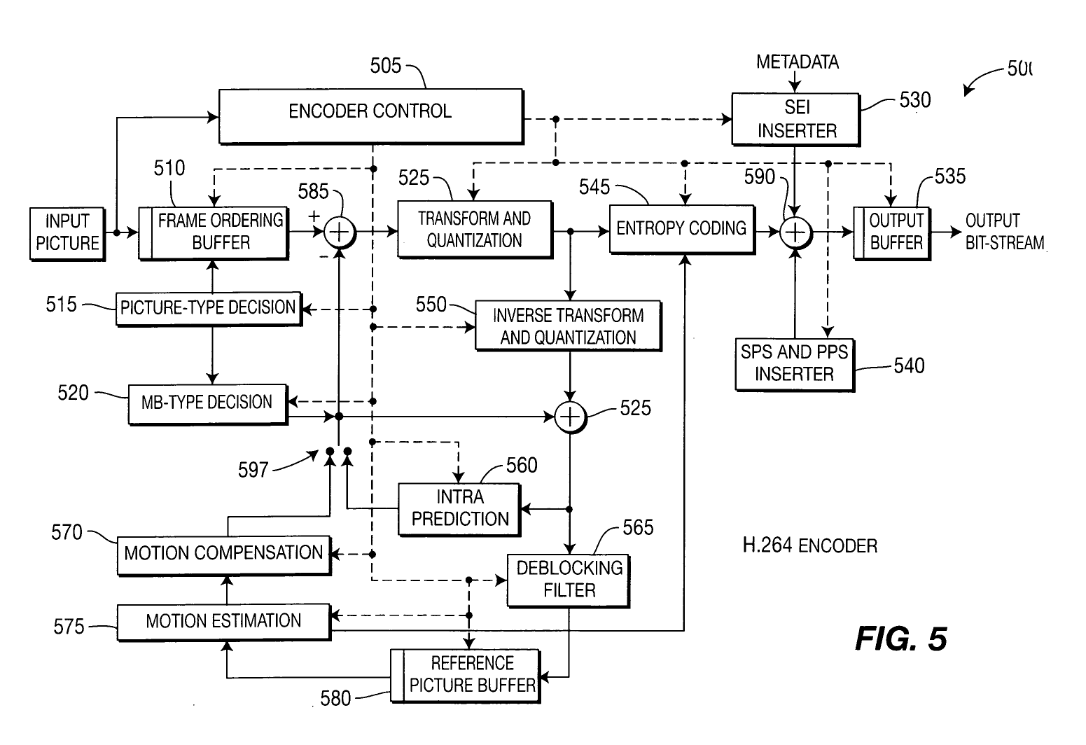

Turning to FIG. 5, a video encoder for use in a multi-pass video encoding system to which the present principles may be applied is indicated generally by the reference numeral 500.

The video encoder 500 includes a frame ordering buffer 510 having an output in signal communication with a non-inverting input of a combiner 585. An output of the combiner 585 is connected in signal communication with a first input of a transformer and quantizer 525. An output of the transformer and quantizer 525 is connected in signal communication with a first input of an entropy coder 545 and a first input of an inverse transformer and inverse quantizer 550. An output of the entropy coder 545 is connected in signal communication with a first non-inverting input of a combiner 590. An output of the combiner 590 is connected in signal communication with a first input of an output buffer 535.

A first output of an encoder controller 505 is connected in signal communication with a second input of the frame ordering buffer 510, a second input of the inverse transformer and inverse quantizer 550, an input of a picture-type decision module 515, an input of a macroblock-type (MB-type) decision module 520, a second input of an intra prediction module 560, a second input of a deblocking filter 565, a first input of a motion compensator 570, a first input of a motion estimator 575, and a second input of a reference picture buffer 580.

A second output of the encoder controller 505 is connected in signal communication with a first input of a Supplemental Enhancement Information (SEI) inserter 530, a second input of the transformer and quantizer 525, a second input of the entropy coder 545, a second input of the output buffer 535, and an input of the Sequence Parameter Set (SPS) and Picture Parameter Set (PPS) inserter 540.

A first output of the picture-type decision module 515 is connected in signal communication with a third input of a frame ordering buffer 510. A second output of the picture-type decision module 515 is connected in signal communication with a second input of a macroblock-type decision module 520.

An output of the Sequence Parameter Set (SPS) and Picture Parameter Set (PPS) inserter 540 is connected in signal communication with a third non-inverting input of the combiner 590.

An output of the inverse quantizer and inverse transformer 550 is connected in signal communication with a first non-inverting input of a combiner 525. An output of the combiner 525 is connected in signal communication with a first input of the intra prediction module 560 and a first input of the deblocking filter 565. An output of the deblocking filter 565 is connected in signal communication with a first input of a reference picture buffer 580. An output of the reference picture buffer 580 is connected in signal communication with a second input of the motion estimator 875. A first output of the motion estimator 575 is connected in signal communication with a second input of the motion compensator 570. A second output of the motion estimator 575 is connected in signal communication with a third input of the entropy coder 545.

An output of the motion compensator 570 is connected in signal communication with a first input of a switch 597. An output of the intra prediction module 560 is connected in signal communication with a second input of the switch 597. An output of the macroblock-type decision module 520 is connected in signal communication with a third input of the switch 597. An output of the switch 597 is connected in signal communication with a second non-inverting input of the combiner 525 and with an inverting input of the combiner 585.

Inputs of the frame ordering buffer 510 and the encoder controller 505 are available as input of the encoder 500, for receiving an input picture 501. Moreover, an input of the Supplemental Enhancement Information (SEI) inserter 530 is available as an input of the encoder 500, for receiving metadata. An output of the output buffer 535 is available as an output of the encoder 500, for outputting a bitstream.

As noted above, the present principles are directed to a method and apparatus for efficient first-pass encoding in a multi-pass encoder. In an embodiment, the present principles are implemented in a variable bit-rate multi-pass video encoder. An aim of a variable bit-rate multi-pass encoder is to provide a constant video quality by varying the bit-allocation among different pictures. In order to do so, a first-pass is typically used to collect information on the video to be coded. The first-pass can be either a pre-analysis or a full-encoding. A first-pass with a full-encoding collects more reliable information about the video complexity and yields better video quality compared to pre-analysis. However, a full-encoding is computationally more complex. In order to keep the complexity low, in an embodiment, a method and apparatus described herein with respect to the present principles perform sub-sampling of the input video sequence to perform fast and efficient first-pass video encoding. In an embodiment, the sub-sampling method includes spatial sub-sampling techniques and/or temporal sub-sampling techniques. It is to be appreciated that different embodiments for performing spatial and temporal sub-sampling are also proposed herein.

In addition, in an embodiment, we also propose a sub-sampling analyzer which analyzes the information obtained from the first-pass encoding and provides more reliable information to a complexity analyzer when the proposed sub-sampling technique in accordance with the present principles or any other pre-analysis technique is used. That is, the sub-sampling analyzer provided herein is not solely limited to a first-pass full encoding with sub-sampling as described herein in accordance with the present principles but, given the teachings of the present principles provided herein, may also be used by one of ordinary skill in this and related arts with other types of first-pass full encoding schemes, while maintaining the spirit of the present principles.

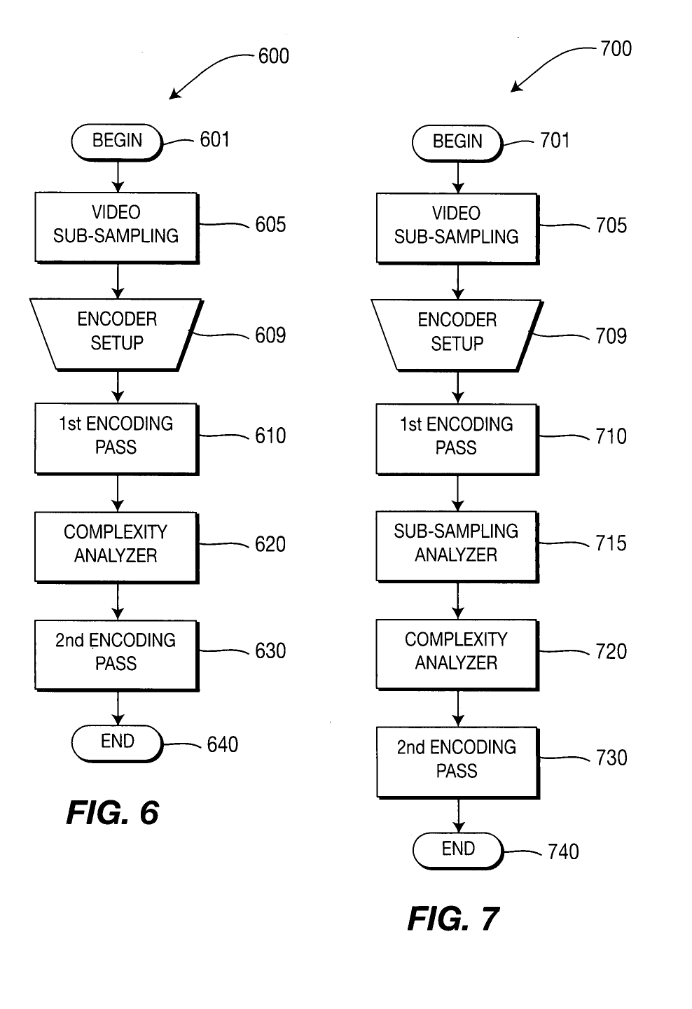

In accordance with various embodiments of the present principles, we propose several exemplary approaches to speed-up the first pass encoding of a multi-pass video encoder, while still providing accurate measures of the video information. In an embodiment, this is done by sub-sampling the input video sequence. In FIG. 4, the function block 405 illustrates an exemplary location for a proposed video sub-sampling block within an overall multi-pass video encoding system 400. The proposed sub-sampling can be done by reducing the spatial resolution and/or the temporal resolution. An exemplary method for multi-pass video encoding using sub-sampling is shown and described herein below with respect to FIG. 6. It is to be appreciated that the present principles are not solely limited to the following methods described herein, or the various variations thereof described herein. That is, given the teachings of the present principles provided herein, one of ordinary skill in this and related arts will contemplate these and various other ways in which to perform sub-sampling of the input video for efficient first-pass encoding in a multi-pass encoder, while maintaining the spirit of the present principles.

### Method 1: Reducing the Spatial Resolution

In an embodiment relating to a first method (hereinafter “first method”) in accordance with the present principles, the spatial resolution of the input video sequence is reduced before being processed in the first-pass. It is to be appreciated that the first method could be applied to both a pre-analysis pass and a full-encoding first pass. The first method reduces the number of samples that are processed in the first-pass and does not alter in any way the first-pass processing method.

In an embodiment relating to the first method, the spatial resolution reduction could be obtained by sub-sampling the number of pixels of the input pictures in order to get a smaller resolution such as half or quarter resolution. It is to be appreciated that the sub-sampling can be performed in different ways either by nearest neighbor or by using an interpolation filter-based method including but not limited to bilinear or bi-cubic image interpolation. It is to be further appreciated that the preceding ways to perform sub-sampling are merely illustrative and, given the teachings of the present principles provided herein, one of ordinary skill in this and related arts will contemplate these and various other ways in which to perform sub-sampling to provide efficient first-pass encoding in a multi-pass encoder in accordance with the present principles, while maintaining the spirit of the present principles.

In another embodiment relating to the first method, the spatial resolution reduction could be obtained by cropping the full-resolution input picture to a smaller resolution such as half or quarter resolution. The smaller resolution can be obtained by various cropping methods. For example, ¼ of the width and ¼ of the height can be cropped from the right, left, top and bottom of the image symmetrically to obtain half resolution. As another example, different numbers of horizontal pixels can be cropped from the bottom and top of the image, and/or different numbers of vertical pixels from the left and right side of the image, asymmetrically.

### Method 2: Reducing the Temporal Resolution

In an embodiment relating to a second method (hereinafter “second method) in accordance with the present principles, the temporal resolution of the input video sequence is reduced before being processed in the first-pass. The second method could be applied to both a pre-analysis pass and a full-encoding first pass as in the case of the first method.

One difference between the second method as compared to the first method is that the second method reduces the number of samples that are processed in the first-pass while keeping the picture sizes same as the original picture size. Similar to the first method, the second method does not alter in any way the first-pass processing method.

In an embodiment relating to the second method, temporal resolution reduction could be obtained by regular sub-sampling by skipping one SOP (Set of Pictures) every other SOP. In this embodiment, the number of pictures that are skipped may be equal to the number of pictures in one SOP. SOP length can be any number bigger than or equal to 1.

In another embodiment relating to the second method, temporal resolution reduction could be obtained by regular skipping the last N pictures of each SOP, where N is less than the SOP length.

In yet another embodiment relating to the second method, temporal resolution reduction could be obtained by irregularly skipping the first M pictures of each SOP, where M is less than the SOP length.

### Method 3: Reducing both Spatial and Temporal Resolution

In an embodiment relating to a third method (hereinafter “third method”) in accordance with the present principles, both the spatial and the temporal resolution of the input video sequence is reduced before being processed in the first-pass. This method could be applied to both a pre-analysis pass and a full-encoding first pass as in the case of the first method and the second method.

The third method includes every possible combination of the first method the second method including but not limited to the following embodiments.

In an embodiment, spatial sub-sampling to half resolution could be combined with regular temporal sub-sampling by skipping every other SOP.

In another embodiment, spatial sub-sampling to half resolution could be combined with irregular temporal sub-sampling.

The described first, second, and third methods could be easily applied to support multi-pass encoding algorithms with more than two passes. The described methods can also be applied prior to pre-analysis based multi-pass encoders.

### Proposed Method to Perform Information Analysis to Provide Reliable Information to Complexity Analysis

In typical multi-pass encoders, information obtained from the first pass encoder is analyzed by the complexity analyzer. The efficiency of the complexity analyzer depends on the reliability and the amount of information available to the complexity analyzer. In an embodiment, we also propose a method to analyze and process the information obtained from the first-pass, and generate more reliable information for the complexity analyzer. The multi-pass video encoder block diagram with the proposed analyzer block is shown and described with respect to FIG. 4, and a corresponding method using the proposed information analysis is shown and described with respect to FIG. 7. The proposed sub-sampling analyzer can be used either when the proposed sub-sampling methods are on or when other pre-analysis methods are used in the multi-pass encoding system.

The sub-sampling analyzer takes the information including, but not limited to, quantization parameters, bits per picture, and picture type, from the first pass encoding that is run with the proposed video sub-sampling block and estimates information for the non-sub-sampled video that will be used by the complexity analyzer. The following estimation procedure can be used in a particular embodiment where information for the first pass without sub-sampling is estimated by information obtained after the first pass with sub-sampling.

Presume that the average QP (quantization parameter) of P (predictive) pictures in one set of picture needs to be estimated, where qₚ_{_{—}}ₚₐₛₛ₁ represents that variable. We want to estimate qₚ_{_{—}}ₚₐₛₛ₁ by using the average quantization parameters of P pictures (i.e., qₚ_{_{—}}ₚₐₛₛ₁_{_{—}}_{subsampled}), B (bi-predictive) pictures (i.e., q_{B}_{_{—}}ₚₐₛₛ₁_{_{—}}_{subsampled}) and I (intra) (i.e., q_{I}_{_{—}}ₚₐₛₛ₁_{_{—}}_{subsampled}) pictures that are obtained from the first pass with the proposed sub-sampling method and first-pass encoding thereafter. Then qₚ_{_{—}}ₚₐₛₛ₁ can be estimated as follows:

qₚ_{_{—}}ₚₐₛₛ₁=α_{I}q_{I}_{_{—}}ₚₐₛₛ₁_{_{—}}_{subsampled}+α_{P}qₚ_{_{—}}ₚₐₛₛ₁_{_{—}}_{subsampled}+α_{B}q_{B}_{_{—}}ₚₐₛₛ₁_{_{—}}_{subsampled} (1)

where α_{I}, α_{P}, α_{B} are the weighting coefficients and q_{I}_{_{—}}ₚₐₛₛ₁_{_{—}}_{subsampled} q_{B}_{_{—}}ₚₐₛₛ₁_{_{—}}_{subsampled} are the known values (information obtained from first-pass encoding with the proposed sub-sampling method). The weighting factors α=[α_{I}α_{P}α_{B}] can be obtained by using training data. In other words, simulations can be performed off-line by using various SOP lengths and SOP structures to find these coefficients that best estimate the first-pass information with non-sub-sampled video.

One way to find the weighting coefficients is by solving the following equation:

$$[ \begin{matrix}{q}_{I\_pass 1 \_subsampled \_sop 1} & {q}_{P\_pass 1 \_subsampled \_sop 1} & {q}_{B\_pass 1 \_subsampled \_sop 1} \\ {q}_{I\_pass 1 \_subsampled \_sop 2} & {q}_{P\_pass 1 \_subsampled \_sop 2} & {q}_{B \_pass 1 \_subsampled \_sop 2} \\ ⋮ & ⋮ & ⋮ \\ {q}_{I\_pass 1 \_subsampled \_sopN} & {q}_{P\_pass 1 \_subsampled \_sopN} & {q}_{B \_pass 1 \_subsampled \_sopN}\end{matrix} ] \cdot [ \begin{matrix}{α}_{I} \\ {α}_{P} \\ {α}_{B}\end{matrix} ] = [ \begin{matrix}{q}_{P\_pass 1 \_sop 1} \\ {q}_{P\_pass 1 \_sop 2} \\ ⋮ \\ {q}_{P\_pass 1 \_sopN}\end{matrix} ] \qquad ( 2 )$$

where q_{I}_{_{—}}ₚₐₛₛ₁_{_{—}}_{subsampled}_{_{—}}ₛₒₚ₁ to q_{I}_{_{—}}ₚₐₛₛ₁_{_{—}}_{subsampled}_{_{—}}_{sopN}, q_{P}_{_{—}}ₚₐₛₛ₁_{_{—}}_{subsampled}_{_{—}}ₛₒₚ₁ to q_{P}_{_{—}}ₚₐₛₛ₁_{_{—}}_{subsampled}_{_{—}}_{sopN}, q_{B}_{_{—}}ₚₐₛₛ₁_{_{—}}_{subsampled}_{_{—}}ₛₒₚ₁ to q_{B}_{_{—}}ₚₐₛₛ₁_{_{—}}_{subsampled}_{_{—}}_{sopN}, qₚ_{_{—}}ₚₐₛₛ₁_{_{—}}ₛₒₚ₁ to q_{P}_{_{—}}ₚₐₛₛ₁_{_{—}}_{sopN} are obtained from simulations.

In the above example, estimation of a quantization parameter for a P picture is demonstrated. The same estimation procedure can be used to estimate quantization parameters or bits of P, I or B pictures as well. Furthermore, a first pass encoding that uses different pre-analysis algorithms can also benefit from the proposed sub-sampling analyzer.

Turning to FIG. 6, an exemplary method for multi-pass video encoding with sub-sampling is indicated generally by the reference numeral 600.

The method 600 includes a start block 601 that passes control to a function block 605. The function block 605 performs video sub-sampling, and passes control to a function block 609 (e.g., a manual operation function block). The function block 609 involves performing an encoder setup, and passes control to a function block 610. The function block 610 performs a first encoding pass, and passes control to a function block 620. The function block 620 performs a complexity analysis, and passes control to a function block 630. The function block 630 performs a second encoding pass, and passes control to an end block 640.

Turning to FIG. 7, an exemplary method for multi-pass video encoding with sub-sampling and information analysis is indicated generally by the reference numeral 600.

The method 700 includes a start block 701 that passes control to a function block 705. The function block 705 performs video sub-sampling, and passes control to a function block 709 (e.g., a manual operation function block). The function block 709 involves performing an encoder setup, and passes control to a function block 710. The function block 710 performs a first encoding pass, and passes control to a function block 715. The function block 715 performs a sub-sampling analysis, and passes control to a function block 720. The function block 720 performs a complexity analysis, and passes control to a function block 730. The function block 730 performs a second encoding pass, and passes control to an end block 740.

A description will now be given of some of the many attendant advantages/features of the present invention, some of which have been mentioned above. For example, one advantage/feature is an apparatus that includes a multi-pass video encoder for performing a first-pass encoding of input image data for at least one picture by sub-sampling at least a portion of the input image data prior to the first-pass encoding. The sub-sampling is at least one of spatial sub-sampling and temporal sub-sampling.

Another advantage/feature is the apparatus having the multi-pass video encoder as described above, wherein the multi-pass video encoder spatially sub-samples at least the portion of the input image data by reducing a spatial resolution of at least one of the at least one picture.

Another advantage/feature is the apparatus having the multi-pass video encoder that reduces the spatial resolution of at least one of the at least one picture as described above, wherein the multi-pass video encoder temporally sub-samples at least the portion of the input image data by regularly skipping at least one of the at least one picture.

Yet another advantage/feature is the apparatus having the multi-pass video encoder that reduces the spatial resolution of at least one of the at least one picture as described above, wherein the multi-pass video encoder temporally sub-samples at least the portion of the input image data by irregularly skipping at least one of the at least one picture.

Still another advantage/feature is the apparatus having the multi-pass video encoder as described above, wherein the multi-pass video encoder spatially sub-samples at least the portion of the input image data by cropping at least one of the at least one picture.

Moreover, another advantage/feature is the apparatus having the multi-pass video encoder that crops the at least one of the at least one picture as described above, wherein the multi-pass video encoder temporally sub-samples at least the portion of the input image data by regularly skipping at least one of the at least one picture.

Further, another advantage/feature is the apparatus having the multi-pass video encoder that crops the at least one of the at least one picture as described above, wherein the multi-pass video encoder temporally sub-samples at least the portion of the input image data by irregularly skipping at least one of the at least one picture.

Also, another advantage/feature is the apparatus having the multi-pass video encoder as described above, wherein the multi-pass video encoder temporally sub-samples at least the portion of the input image data by regularly skipping at least one of the at least one picture.

Additionally, another advantage/feature is the apparatus having the multi-pass video encoder as described above, wherein the multi-pass video encoder temporally sub-samples at least the portion of the input image data by irregularly skipping at least one of the at least one picture.

Moreover, another advantage/feature is the apparatus having the multi-pass video encoder as described above, wherein the multi-pass video encoder performs an analysis of information from the first-pass encoding prior to a complexity analysis of the information, the information for use in a subsequent-pass encoding.

Moreover, another advantage/feature is the apparatus having the multi-pass video encoder that performs the analysis of the information from the first-pass encoding prior to the complexity analysis of the information as described above, wherein the analysis of the information from the first-pass encoding prior to the complexity analysis, is performed to provide a statistical estimation of compression parameters for the input image data for the subsequent-pass encoding.

Further, another advantage/feature is the apparatus having the multi-pass video encoder that performs the analysis of the information from the first-pass encoding prior to the complexity analysis of the information as described above, wherein the statistical estimation of the compression parameters relates to the input image data without sub-sampling.

Also, another advantage/feature is the apparatus having the multi-pass video encoder that performs the analysis of the information from the first-pass encoding prior to the complexity analysis of the information as described above, wherein the information comprises at least one of quantization parameters, bits per picture, and picture type.

Additionally, another advantage/feature is an apparatus for use in a multi-pass video encoder. The encoder is for at least performing a first-pass encoding of input image data for at least one picture. The apparatus includes a sub-sampler for sub-sampling at least a portion of the input image data prior to the first-pass encoding. The sub-sampling is at least one of spatial sub-sampling and temporal sub-sampling.

Moreover, another advantage/feature is the apparatus having the sub-sampler as described above, wherein the sub-sampler spatially sub-samples at least the portion of the input image data by reducing a spatial resolution of at least one of the at least one picture.

Moreover, another advantage/feature is the apparatus having the sub-sampler that reduces the spatial resolution of at least one of the at least one picture as described above, wherein the sub-sampler temporally sub-samples at least the portion of the input image data by regularly skipping at least one of the at least one picture.

Further, another advantage/feature is the apparatus having the sub-sampler that reduces the spatial resolution of at least one of the at least one picture as described above, wherein the sub-sampler temporally sub-samples at least the portion of the input image data by irregularly skipping at least one of the at least one picture.

Also, another advantage/feature is the apparatus having the sub-sampler as described above, wherein the sub-sampler spatially sub-samples at least the portion, of the input image data by cropping at least one of the at least one picture.

Additionally, another advantage/feature is the apparatus having the sub-sampler that crops at least one of the at least one picture as described above, wherein the sub-sampler temporally sub-samples at least the portion of the input image data by regularly skipping at least one of the at least one picture.

Moreover, another advantage/feature is the apparatus having the sub-sampler that crops at least one of the at least one picture as described above, wherein the sub-sampler temporally sub-samples at least the portion of the input image data by irregularly skipping at least one of the at least one picture.

Further, another advantage/feature is the apparatus having the sub-sampler as described above, wherein the sub-sampler temporally sub-samples at least the portion of the input image data by regularly skipping at least one of the at least one picture.

Also, another advantage/feature is the apparatus having the sub-sampler as described above, wherein the sub-sampler temporally sub-samples at least the portion of the input image data by irregularly skipping at least one of the at least one picture.

Additionally, another advantage/feature is the apparatus having the sub-sampler as described above, further including a sub-sampling analyzer for performing an analysis of information from the first-pass encoding prior to a complexity analysis of the information. The information is for use in a subsequent-pass encoding.

Moreover, another advantage/feature is the apparatus having the sub-sampler and the sub-sampling analyzer as described above, wherein the analysis of the information from the first-pass encoding prior to the complexity analysis, is performed to provide a statistical estimation of compression parameters for the input image data for the subsequent-pass encoding.

Further, another advantage/feature is the apparatus having the sub-sampler and the sub-sampling analyzer as described above, wherein the statistical estimation of the compression parameters relates to the input image data without sub-sampling.

Also, another advantage/feature is the apparatus having the sub-sampler and the sub-sampling analyzer as described above, wherein the information comprises at least one of quantization parameters, bits per picture, and picture type.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a multi-pass video encoder for performing a first-pass encoding of input image data for at least one picture by sub-sampling at least a portion of the input image data prior to the first-pass encoding,
wherein the sub-sampling is at least one of spatial sub-sampling and temporal sub-sampling.

2. The apparatus of claim 1, wherein said multi-pass video encoder spatially sub-samples at least the portion of the input image data by reducing a spatial resolution of at least one of the at least one picture.

3. The apparatus of claim 2, wherein said multi-pass video encoder temporally sub-samples at least the portion of the input image data by regularly skipping at least one of the at least one picture.

4. The apparatus of claim 2, wherein said multi-pass video encoder temporally sub-samples at least the portion of the input image data by irregularly skipping at least one of the at least one picture.

5. The apparatus of claim 1, wherein said multi-pass video encoder spatially sub-samples at least the portion of the input image data by cropping at least one of the at least one picture.

6. The apparatus of claim 5, wherein said multi-pass video encoder temporally sub-samples at least the portion of the input image data by regularly skipping at least one of the at least one picture.

7. The apparatus of claim 5, wherein said multi-pass video encoder temporally sub-samples at least the portion of the input image data by irregularly skipping at least one of the at least one picture.

8. The apparatus of claim 1, wherein said multi-pass video encoder temporally sub-samples at least the portion of the input image data by regularly skipping at least one of the at least one picture.

9. The apparatus of claim 1, wherein said multi-pass video encoder temporally sub-samples at least the portion of the input image data by irregularly skipping at least one of the at least one picture.

10. The apparatus of claim 1, wherein said multi-pass video encoder performs an analysis of information from the first-pass encoding prior to a complexity analysis of the information, the information for use in a subsequent-pass encoding.

11. The apparatus of claim 10, wherein the analysis of the information from the first-pass encoding prior to the complexity analysis, is performed to provide a statistical estimation of compression parameters for the input image data for the subsequent-pass encoding.

12. A method, comprising:
performing a first-pass encoding of input image data for at least one picture by sub-sampling at least a portion of the input image data prior to the first-pass encoding,
wherein the sub-sampling is at least one of spatial sub-sampling and temporal sub-sampling.

13. The method of claim 12, wherein said sub-sampling step spatially sub-samples at least the portion of the input image data by reducing a spatial resolution of at least one of the at least one picture.

14. The method of claim 13, wherein said sub-sampling step temporally sub-samples at least the portion of the input image data by regularly skipping at least one of the at least one picture.

15. The method of claim 13, wherein said sub-sampling step temporally sub-samples at least the portion of the input image data by irregularly skipping at least one of the at least one picture.

16. The method of claim 12, wherein said sub-sampling step spatially sub-samples at least the portion of the input image data by cropping at least one of the at least one picture.

17. The method of claim 16, wherein said sub-sampling step temporally sub-samples at least the portion of the input image data by regularly skipping at least one of the at least one picture.

18. The method of claim 16, wherein said sub-sampling step temporally sub-samples at least the portion of the input image data by irregularly skipping at least one of the at least one picture.

19. The method of claim 12, wherein said sub-sampling step temporally sub-samples at least the portion of the input image data by regularly skipping at least one of the at least one picture.

20. The method of claim 12, wherein said sub-sampling step temporally sub-samples at least the portion of the input image data by irregularly skipping at least one of the at least one picture.

21. The method of claim 13, further comprising performing an analysis of information from the first-pass encoding prior to a complexity analysis of the information, the information for use in a subsequent-pass encoding.

22. The method of claim 21, wherein the analysis of the information from the first-pass encoding prior to the complexity analysis, is performed to provide a statistical estimation of compression parameters for the input image data for the subsequent-pass encoding.

23. An apparatus, comprising:
a multi-pass video encoder for performing a first-pass encoding of input image data for at least one picture, and performing an analysis of information from the first-pass encoding to enhance a reliability of the information for use in a subsequent complexity analysis occurring before a subsequent-pass encoding.

24. A method, comprising:
performing a first-pass encoding of input image data for at least one picture; and
performing an analysis of information from the first-pass encoding to enhance a reliability of the information for use in a subsequent complexity analysis occurring before a subsequent-pass encoding.

25. The method of claim 24, wherein the analysis of the information from the first-pass encoding prior to the complexity analysis, is performed to provide a statistical estimation of compression parameters for the input image data for the subsequent-pass encoding.
